(19) United States
(12) Patent Application Publication
(10) Pub. No.: US 2006/0181811 A1
(43) Pub. Date: Aug. 17, 2006

(54) Tolerance ring with debris-reducing profile

(76) Inventors: Kevin P. Hanrahan, Santa Barbara, CA (US); David D. Dexter, Buellton, CA (US); Ryan J. Schmidt, Santa Barbara, CA (US); Matthew S. Sprankle, Santa Barbara, CA (US)

Correspondence Address: SNELL & WILMER LLP, 600 ANTON BOULEVARD, SUITE 1400, COSTA MESA, CA, 92626, US

(21) Appl. No.: 11/059,813

(22) Filed: Feb. 17, 2005

(51) Int. Cl. G11B 5/48

(52) U.S. Cl. 360/265.2

(57) ABSTRACT

A tolerance ring for applications requiring cleanliness has contacting portions having a novel profile that reduces debris generation during installation of the tolerance ring while still providing adequate stiffness after installation. The tolerance ring is suitable for cylindrical interface applications where both a reduction in debris generation and high interface stiffness are desirable, such as the interface between an actuator pivot bearing and an actuator arm in a magnetic hard disk drive.

### BACKGROUND OF THE INVENTION

1. Field of the Invention

This invention relates generally to tolerance rings designed for use in clean environments and particularly to tolerance rings for use in information storage devices.

2. Description of Related Art

In hard disk drives, magnetic heads read and write data on the surfaces of co-rotating disks that are co-axially mounted on a spindle motor. The magnetically-written “bits” of written information are therefore laid out in concentric circular “tracks” on the surfaces of the disks. The disks must rotate quickly so that the computer user does not have to wait long for a desired bit of information on the disk surface to translate to a position under the head. In modern disk drives, data bits and tracks must be extremely narrow and closely spaced to achieve a high density of information per unit area of the disk surface.

The required small size and close spacing of information bits on the disk surface have consequences on the design of the disk drive device and its mechanical components. Among the most important consequences is that the magnetic transducer on the head must operate in extremely close proximity to the magnetic surface of the disk. However, because there is relative motion between the disk surface and the head due to the disk rotation and head actuation, continuous contact between the head and disk can lead to tribological failure of the interface. Such tribological failure, known colloquially as a “head crash,” can damage the disk and head, and usually causes data loss. Therefore, the magnetic head is typically designed to be hydrodynamically supported by an extremely thin air bearing so that its magnetic transducer can operate in close proximity to the disk while physical contacts between the head and the disk are minimized or avoided.

The head-disk spacing present during operation of modern hard disk drives is extremely small—measuring in the tens of nanometers. Obviously, for the head to operate so closely to the disk the head-disk interface must be kept clear of debris and contamination—even microscopic debris and contamination. In addition to tribological consequences, contamination and debris at or near the head disk interface can force the head away from the disk. The resulting temporary increases in head-disk spacing cause magnetic read/write errors. Accordingly, magnetic hard disk drives are assembled in clean-room conditions and the constituent parts are subjected to pre-assembly cleaning steps during manufacture.

Another consequence of the close spacing of information bits and tracks written on the disk surface is that the spindle rotation and head actuator motion must be of very high precision. The head actuator must have structural characteristics that allow it to be actively controlled to quickly seek different tracks of information and then precisely follow small disturbances in the rotational motion of the disk while following such tracks.

Characteristics of the actuator structure that are important include stiffness, mass, geometry, and boundary conditions. For example, one important boundary condition is the rigidity of the interface between the actuator arm and the actuator pivot bearing.

All structural characteristics of the actuator, including those mentioned above, must be considered by the designer to minimize vibration in response to rapid angular motions and other excitations. For example, the actuator arm cannot be designed to be too massive because it must accelerate very quickly to reach information tracks containing desired information. Otherwise, the time to access desired information may be unacceptable to the user.

On the other hand, the actuator arm must be stiff enough and the actuator pivot bearing must be of high enough quality so that the position of the head can be precisely controlled during operation. Also, the interface between the actuator arm and the pivot bearing must be of sufficient rigidity and strength to enable precise control of the head position during operation and to provide the boundary conditions necessary to facilitate higher natural resonant frequencies of vibration of the actuator arm structure.

Actuator arm stiffness must also be sufficient to limit deflection that might cause contact with the disk during mechanical shock events that may occur during operation or non-operation. Likewise, the interface between the actuator arm and the pivot bearing must be of sufficient strength to prevent catastrophic structural failure such as axial slippage between the actuator arm and the actuator pivot bearing sleeve during large mechanical shock events.

In many disk drives, the actuator arm (or arms) is fixed to the actuator pivot bearing sleeve by a tolerance ring. Typically, tolerance rings include a cylindrical base portion and a plurality of contacting portions that are raised or recessed from the cylindrical base portion. The contacting portions are typically partially compressed during installation to create a radial preload between the mating cylindrical features of the parts joined by the tolerance ring. The radial preload compression provides frictional engagement that prevents axial slippage of the mating parts. For example, in disk drive applications, the radial compressive preload of the tolerance ring prevents separation and slippage at the interface between the actuator arm and the pivot bearing during operation and during mechanical shock events. The tolerance ring also acts as a radial spring. In this way, the tolerance ring positions the interior cylindrical part relative to the exterior cylindrical part while making up for radii clearance and manufacturing variations in the radius of the parts.

Additional features have been added to tolerance rings to obtain other specific advantages. For example, U.S. Pat. No. 6,288,878 to Misso et al., discloses a tolerance ring to which circumferential brace portions have been added to increase hoop strength.

U.S. Pat. No. 4,790,683 to Cramer, Jr. et al., discloses the use of a conventional tolerance ring in conjunction with a cylindrical shim in applications characterized by structurally significant radial vibration or loading, where the shim prevents deformation of a soft underlying material and thereby prevents undesirable partial relief of the radial compression that maintains frictional engagement of the tolerance ring.

U.S. Pat. Nos. 6,411,472 and 6,480,363 disclose tolerance rings to which a viscoelastic damping layer has been added (in a laminar structure) for enhanced vibration control.

U.S. Pat. No. 6,333,839 to Misso et al., discloses a tolerance ring having a profile designed to control the axial force required to install the tolerance ring, so as to reduce the maximum axial installation force and render that force more consistent to enhance manufacturability.

State of the art tolerance rings are typically manufactured from a flat metal sheet with stamping, forming, rolling, and other steps to provide raised or recessed contacting regions and a final generally-cylindrical shape. The tolerance ring can be installed first into a generally cylindrical hole in an exterior part (e.g. actuator arm) so that later a generally cylindrical inner part (e.g. actuator pivot bearing) can be forcibly pushed into the interior of the tolerance ring to create a radial compressive preload that retains the parts by frictional engagement. In this case, the contacting portions are typically recessed to a lesser radius than the base portion. Alternatively, the tolerance ring can be installed first around a generally cylindrical inner part (e.g. actuator pivot bearing) so that later the inner part together with the tolerance ring can be forcibly pushed into the interior of a generally cylindrical hole in an exterior part (e.g. actuator arm) to create a radial compressive preload that retains the parts by frictional engagement. In this case, the contacting portions are typically raised to a greater radius than the base portion.

Tribological problems in magnetic disk drives sometimes have non-obvious causes that, once known, understood, and accounted for, give one disk drive manufacturer a competitive edge over another. The present inventors recognized that the forceful insertion of the actuator pivot bearing cartridge into a generally cylindrical hole in the actuator arm body, with interference that radially preloading the tolerance ring, can cause the tolerance ring to shear metal fragments from either the actuator pivot bearing sleeve flange or the actuator arm body (whichever component is not the one to which the tolerance ring is first installed), and such fragments can later contaminate the head-disk interface and ultimately lead to a head crash and possibly to data loss.

The actuator arm structure is typically fabricated from aluminum or an alloy of aluminum and is therefore typically softer and more easily scratched by the tolerance ring than is the pivot bearing sleeve, which is typically fabricated from stainless steel. Therefore, less debris comprising aluminum are generated if a conventional tolerance ring is installed first into a generally cylindrical hole in the actuator arm and then the actuator pivot bearing is forced into the interior of the tolerance ring. However, even when a conventional tolerance ring is installed first into the actuator arm, the stainless steel surface of the actuator pivot bearing may be scraped when it is pushed into the interior of the installed tolerance ring. Consequently, the installation of a conventional tolerance ring is still prone to generate debris.

Most state-of-the-art attempts to improve post-fabrication cleanliness of disk drive components have focused on pre- and post-assembly cleaning steps and on environmental cleanliness during assembly. The industry's marked reliance on pre- and post-assembly cleaning steps survives even though such steps are not thorough in their removal of contaminants and debris. Assembly in clean environments also does not prevent the generation of contaminates and debris during assembly operations performed within those clean environments. Less frequently, disk drive designers consider the generation of debris and contamination earlier in the design of sub-components. Still, such consideration is often restricted to the selection of lubricants and adhesives. Consequently, there remains much scope in the art for reducing debris generation via novel changes to the basic design or assembly of various sub-components of the disk drive.

Therefore, there is a need in the art for a tolerance ring that can generally prevent or generally reduce the creation of debris during assembly rather than relying on debris removal by post-assembly cleaning steps. Although the need in the art was described above in the context of magnetic disk drive information storage devices, the need is also present in other applications where a tolerance ring is used in a clean environment that must remain as free as possible of debris and contaminants.

### SUMMARY OF THE INVENTION

A tolerance ring comprises a substantially cylindrical base portion having a first radius, and a plurality of contacting portions. Each contacting portion has at least one central region that reaches a second radius. Each contacting portion also has at least two circumferential transition regions each being circumferentially adjacent to the central region and spanning from said first radius substantially to said second radius over a circumferential transition length. Each contacting portion also has at least two axial transition regions each being axially adjacent to the central region and spanning from said first radius substantially to said second radius over an axial transition length. The axial transition length is greater than the circumferential transition length.

### BRIEF DESCRIPTION OF THE DRAWINGS

The exact nature of this invention, as well as the objects and advantages thereof, will become readily apparent from consideration of the following specification in conjunction with the accompanying drawings in which like reference numerals designate like parts throughout the figures thereof and wherein:

FIG. 1 is a perspective view of a tolerance ring according to an embodiment of the present invention.

FIG. 2 is a detailed perspective view of a single contacting portion of the tolerance ring of FIG. 1.

FIG. 3 is an axial view of a tolerance ring according to an embodiment of the present invention.

FIG. 4 is a cross-sectional view of the tolerance ring of FIG. 3, taken along the cross-section labeled A-A in FIG. 3.

FIG. 5 is a perspective view of a tolerance ring according to another embodiment of the present invention.

FIG. 6 is a detailed perspective view of a single contacting portion of the tolerance ring of FIG. 5.

FIG. 7 is a side view of a tolerance ring according to an embodiment of the present invention.

FIG. 8 is a cross-sectional view of the tolerance ring of FIG. 7, taken along the cross-section labeled B-B in FIG. 7.

FIG. 9 is an axial view of a tolerance ring according to an embodiment of the present invention.

FIG. 10 is a cross-sectional view of the tolerance ring of FIG. 9, taken along the cross-section labeled A-A in FIG. 9.

FIG. 11 is an exploded view of a disk drive actuator arm assembly including a tolerance ring according to an embodiment of the present invention.

In these figures, similar numerals refer to similar elements in the drawing. It should be understood that the sizes of the different components in the figures may not be to scale, or in exact proportion, and are shown for visual clarity and for the purpose of explanation.

### DETAILED DESCRIPTION OF THE PREFERRED EMBODIMENTS

A tolerance ring for applications requiring cleanliness has contacting portions having a novel profile that reduces debris generation during installation of the tolerance ring while still providing adequate stiffness after installation.

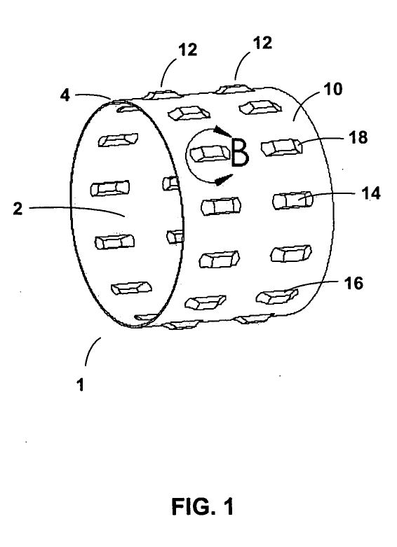

FIG. 1 shows a perspective view of a tolerance ring according to an embodiment of the present invention. The tolerance ring 1 has a cylindrical base portion 10 and a plurality of contacting portions 12. Elastic radial expansion and contraction of cylindrical opening 2 is facilitated by an axially-oriented gap 4 in the circumference of tolerance ring 1. The contacting portions 12 have central regions 14, circumferential transition regions 16, and axial transition regions 18.

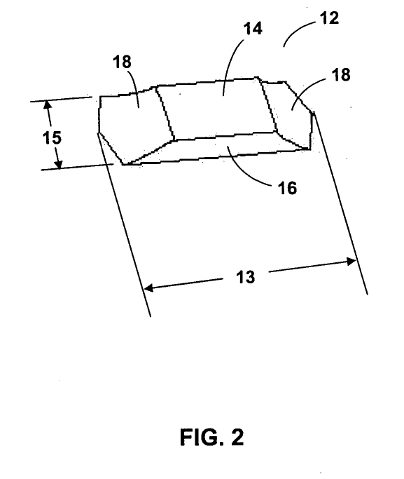

FIG. 2, which is an expanded view of the single contacting portion 12 within detail region B of the previous figure, depicts the foregoing regions with greater clarity. Contacting portion 12 has overall axial length 13 and overall circumferential width 15. Note that circumferential transition regions 16 are steeper than axial transition regions 18, so that circumferential transition regions 16 provide greater radial stiffness. Axial transition regions 18 are rounded and less steep to reduce the generation of contaminating debris during the forceful axial insertion of a cylindrical object (e.g. an actuator pivot bearing cartridge) into the cylindrical opening 2 of the tolerance ring after the radial expansion of the tolerance ring is constrained by its prior installation into a constraining cylinder (e.g. a cylindrical hole in an actuator arm body).

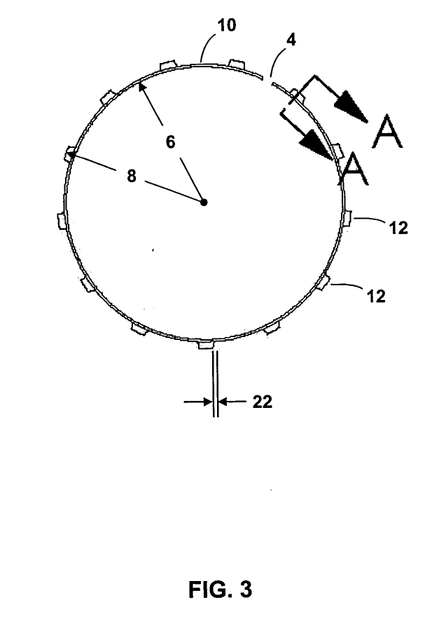

FIG. 3 is an axial view of a tolerance ring according to an embodiment of the present invention. Cylindrical base portion 10 has radius 6, while central regions 14 have radius 8 (which is larger than radius 6 in this embodiment but could have been smaller if the contacting portions were designed to point inward rather than outward). FIG. 3 most clearly depicts the relatively narrow and steep profiles of circumferential transition regions 16, which span from radius 6 to radius 8 over circumferential transition lengths 22.

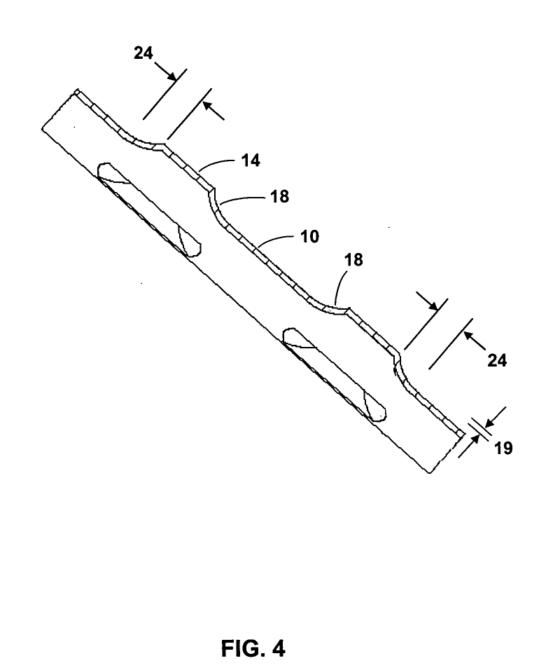

FIG. 4 is a cross-sectional view of the tolerance ring of FIG. 3, taken along the cross-sectional plane labeled A-A in FIG. 3. FIG. 4 most clearly depicts the rounded and more gradual profiles of axial transition regions 18, which span from radius 6 to radius 8 over axial transition lengths 24. In this particular embodiment, axial transition region 18 is characterized by at least one radius of curvature that is at least 2.5 times the thickness 19 of the material from which the tolerance ring is fabricated. In a preferred embodiment, the ratio of axial transition length 24 to overall axial length 13 is more than the ratio of circumferential transition length 22 to overall circumferential width 15, but less than 250 times the ratio of circumferential transition length 22 to overall circumferential width 15. In another preferred embodiment, the ratio of circumferential transition length 22 to overall circumferential width 15 is less than or equal to 0.4.

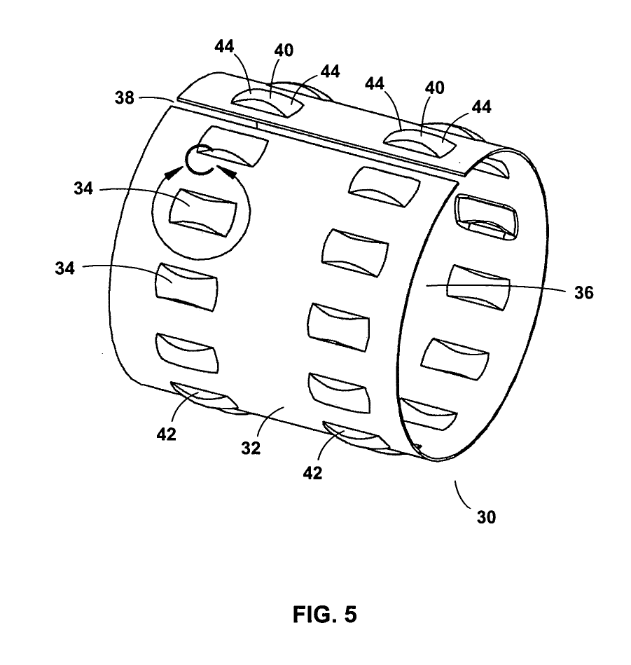

FIG. 5 shows a perspective view of a tolerance ring according to another embodiment of the present invention. The tolerance ring 30 has a cylindrical base portion 32 and a plurality of contacting portions 34. Elastic radial expansion and contraction of cylindrical opening 36 is facilitated by an axially-oriented gap 38 in the circumference of tolerance ring 30. The contacting portions 34 have central regions 40, circumferential transition regions 42, and axial transition regions 44.

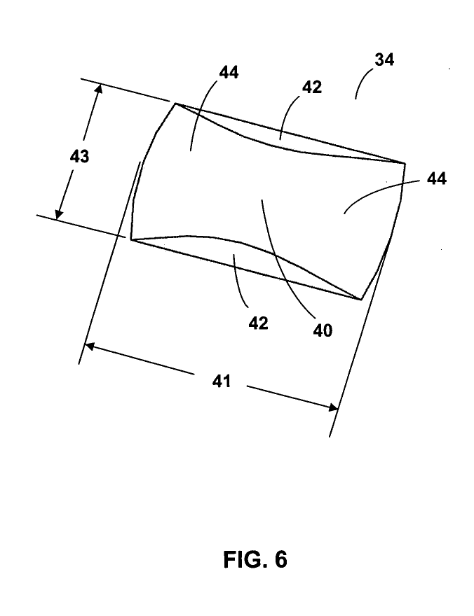

FIG. 6, which is an expanded view of a single contacting portion 34 within detail region C of the previous figure, depicts the foregoing regions with greater clarity. Contacting portion 34 has overall axial length 41 and overall circumferential width 43. Note that circumferential transition regions 42 are steeper than axial transition regions 44, so that circumferential transition regions 42 provide greater radial stiffness. Axial transition regions 44 are rounded and less steep to reduce the generation of contaminating debris during the forceful axial insertion of the tolerance ring into a constraining cylinder (e.g. a cylindrical hole in an actuator arm body), after radial compression of the tolerance ring is first constrained by prior installation of a cylindrical object (e.g. an actuator pivot bearing cartridge) into the cylindrical opening 36 of the tolerance ring.

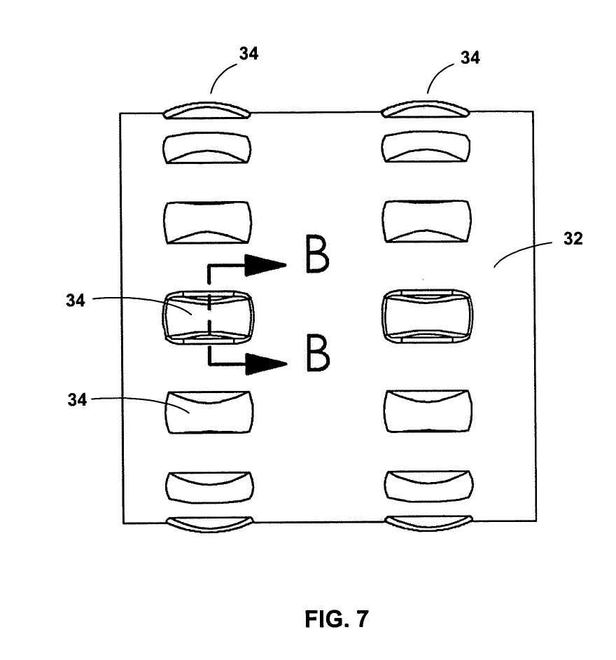

FIG. 7 is a side view of a tolerance ring according to an embodiment of the present invention. Cross-section B-B is shown cutting through a contacting portion 34 along a circumferential direction.

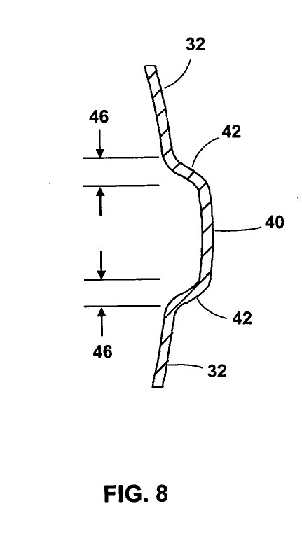

FIG. 8 is a cross-sectional view of the tolerance ring of FIG. 7, taken along the cross-section labeled B-B in FIG. 7. FIG. 8 most clearly depicts the relatively narrow and steep profiles of circumferential transition regions 42, which span from cylindrical base portion 32 to central region 40 over circumferential transition lengths 46.

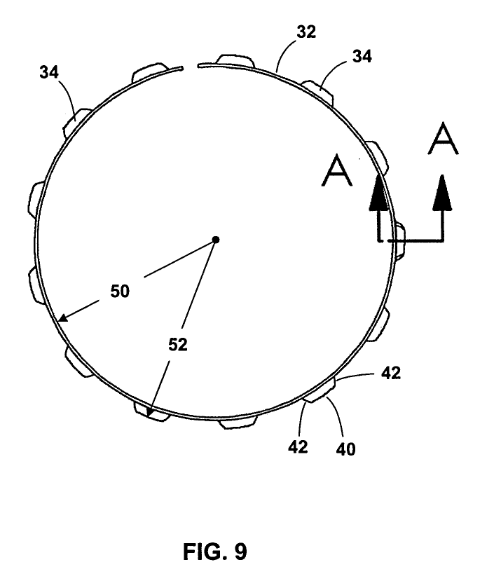

FIG. 9 is an axial view of a tolerance ring according to an embodiment of the present invention. Cylindrical base portion 32 has radius 50, while central regions 40 reach radius 52 (which is larger than radius 50 in this embodiment but could have been smaller if the contacting portions were designed to point inward rather than outward). Cross-section A-A is shown cutting through a contacting portion 34 along an axial direction.

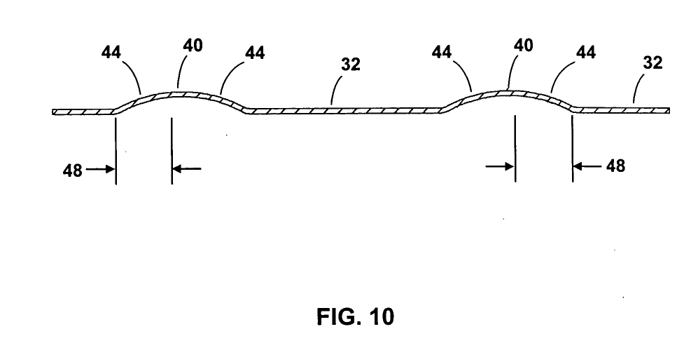

FIG. 10 is a cross-sectional view of the tolerance ring of FIG. 9, taken along the cross-section labeled A-A in FIG. 9. FIG. 10 most clearly depicts the rounded and more gradual profiles of axial transition regions 44, which span from radius 50 to radius 52 over axial transition lengths 48. In a preferred embodiment, the ratio of axial transition length 48 to overall axial length 41 is more than the ratio of circumferential transition length 46 to overall circumferential width 43, but less than 250 times the ratio of circumferential transition length 46 to overall circumferential width 43. In another preferred embodiment, the ratio of circumferential transition length 46 to overall circumferential width 43 is less than or equal to 0.4.

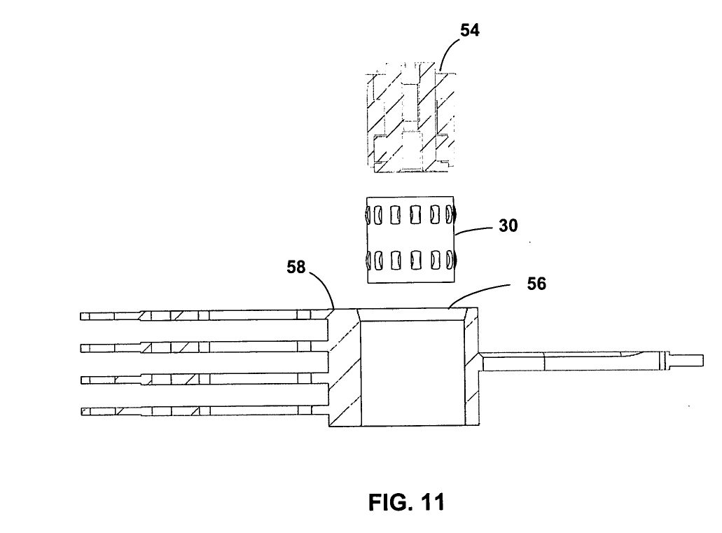

FIG. 11 is an exploded view of a disk drive actuator arm assembly including a tolerance ring according to an embodiment of the present invention. Tolerance ring 30 is designed to fit outside of actuator pivot bearing cartridge 54 and inside a chamfered cylindrical hole 56 in actuator arm body 58.

While the invention has been particularly shown and described with reference to preferred embodiments thereof, it will be understood by those skilled in the art that the foregoing and other changes in form and detail may be made therein without departing from the scope of the invention.

What is claimed is:

1. A tolerance ring, comprising:
a substantially cylindrical base portion having a first radius;
a plurality of contacting portions, each having at least one central region that reaches a second radius, at least two circumferential transition regions each being circumferentially adjacent to the central region and spanning from said first radius substantially to said second radius over a circumferential transition length, and at least two axial transition regions each being axially adjacent to the central region and spanning from said first radius substantially to said second radius over an axial transition length, said axial transition length being greater than said circumferential transition length.

2. The tolerance ring of claim 1, having a material thickness and wherein said axial transition regions have a profile including at least one curve with a radius of curvature of at least 2.5 times said material thickness.

3. The tolerance ring of claim 1, wherein said contacting portions each have an overall axial length and an overall circumferential width, and the ratio of said axial transition length to said overall axial length is more than the ratio of said circumferential transition length to said overall circumferential width, but less than 250 times the ratio of said circumferential transition length to said overall circumferential width.

4. The tolerance ring of claim 1, wherein said contacting portions each have an overall circumferential width, and the ratio of said circumferential transition length to said overall circumferential width is less than or equal to 0.4.

5. An actuator arm assembly for an information storage device, comprising:
an actuator arm; and
an actuator pivot bearing; and
a tolerance ring retaining the actuator pivot bearing relative to the actuator arm, wherein the tolerance ring comprises;
a substantially cylindrical base portion having a first radius; and
a plurality of contacting portions, each having at least one central region that reaches a second radius, at least two circumferential transition regions each being circumferentially adjacent to the central region and spanning from said first radius substantially to said second radius over a circumferential transition length, and at least two axial transition regions each being axially adjacent to the central region and spanning from said first radius substantially to said second radius over an axial transition length, said axial transition length being greater than said circumferential transition length.

6. The actuator arm assembly of claim 5, wherein said contacting portions each have an overall axial length and an overall circumferential width, and the ratio of said axial transition length to said overall axial length is more than the ratio of said circumferential transition length to said overall circumferential width, but less than 250 times the ratio of said circumferential transition length to said overall circumferential width.

7. The actuator arm assembly of claim 5, wherein said contacting portions each have an overall circumferential width, and the ratio of said circumferential transition length to said overall circumferential width is less than or equal to 0.4.

8. The actuator arm assembly of claim 5, wherein said tolerance ring has a material thickness and wherein said axial transition regions have a profile including at least one curve with a radius of curvature of at least 2.5 times said material thickness.

9. A method of fabricating a tolerance ring, comprising:
forming a plurality of contacting portions in metal strip, each having at least one central region that is offset from the plane of the metal strip, and at least two first transition regions each being adjacent to the central region along a first axis and each spanning said offset over a first transition length measured along said first axis, and at least two second transition regions each being adjacent to the central region along a second axis and each spanning said offset over a second transition length measured along said second axis, said second transition length being greater than said first transition length and said second axis being substantially orthogonal to said first axis; and
bending said metal strip into a substantially cylindrical shape, so that said second axis is substantially parallel to the central axis of the cylindrical shape.

10. The method of claim 9, wherein said bending comprises rolling.

11. A method of claim 9, wherein said bending comprises wrapping.

12. The method of assembling an actuator arm assembly for an information storage device, comprising:
forming a plurality of contacting portions in metal strip, each having at least one central region that is offset from the plane of the metal strip, and at least two first transition regions each being adjacent to the central region along a first axis and each spanning said offset over a first transition length measured along said first axis, and at least two second transition regions each being adjacent to the central region along a second axis and each spanning said offset over a second transition length measured along said second axis, said second transition length being greater than said first transition length and said second axis being substantially orthogonal to said first axis; and
bending said metal strip into a substantially cylindrical shape, so that said second axis is substantially parallel to the central axis of the cylindrical shape; and
sliding a bearing cartridge into said substantially cylindrical shape; and then
inserting said bearing cartridge together with said substantially cylindrical shape into a hole in an actuator arm.

13. The method of claim 12, wherein said bending is oriented to bring said central region to an outer radius of said cylindrical shape.

14. A method of assembling an actuator arm assembly for an information storage device, comprising:
forming a plurality of contacting portions in metal strip, each having at least one central region that is offset from the plane of the metal strip, and at least two first transition regions each being adjacent to the central region along a first axis and each spanning said offset over a first transition length measured along said first axis, and at least two second transition regions each being adjacent to the central region along a second axis and each spanning said offset over a second transition length measured along said second axis, said second transition length being greater than said first transition length and said second axis being substantially orthogonal to said first axis; and
bending said metal strip into a substantially cylindrical shape, so that said second axis is substantially parallel to the central axis of the cylindrical shape; and
sliding said substantially cylindrical shape into a hole in an actuator arm; and then
inserting a bearing cartridge into said substantially cylindrical shape.

15. The method of claim 14, wherein said bending is oriented to bring said central region to an inner radius of said cylindrical shape.
